(19) United States
(12) Patent Application Publication
(10) Pub. No.: US 2002/0085367 A1
(43) Pub. Date: Jul. 4, 2002

(54) Two shot injection molded instrument cluster

(76) Inventors: Jerome Francis Maxwell, Livonia, MI (US); Thomas Lee Jones, Ann Arbor, MI (US)

Correspondence Address: Thomas E. Donohue, Artz & Artz, PC, 28333 Telegraph Road Suite 250, Southfield, MI, 48034, US

(21) Appl. No.: 09/750,896

(22) Filed: Dec. 28, 2000

(51) Int. Cl. G01D 11/28

(52) U.S. Cl. 362/29; 362/489

(57) ABSTRACT

An instrument cluster 100 including a backplate 110, a mask 112, the backplate 110 and the mask 112 formed as a single component using a single shot of injection molding, and a dial 114 formed onto the backplate 110 using a second shot of injection molding.

### TECHNICAL FIELD

The present invention relates generally to an instrument cluster for use in an automobile, and more particularly to an instrument cluster produced using a multi-shot injection molding process.

### BACKGROUND ART

Instrument clusters are well known in the automotive industry. Instrument clusters are utilized to provide information to the driver regarding speed, fuel level, and an unlimited variety of other information. Instrument clusters are commonly comprised of a number of individual components manufactured and assembled prior to the instrument cluster being installed in the vehicle.

An instrument cluster may be manufactured using a wide variety of components. One known partial list of components can include a backplate, a dial, a mask, an appliqué, a lens, led backlighting, and mechanical dial mechanisms. The individual components that comprise the instrument cluster are assembled and installed into the dash of the automobile. It is known that as the number of components used to create the instrument cluster increases, it is possible for the cost of the instrument cluster to increase as well. The increase in costs can arise from a number from factors. Separate manufacturing of parts, increased assembly time and effort, warranty concerns arising from vibration of parts, and a variety of other factors can all lead to a relationship between the number of individual components within an instrument cluster, and a resulting increase in cost. It can therefore be highly desirable to reduce the number of individual components used to construct the instrument panel.

One method utilized to produce components for the instrument cluster is injection molding. Although standard one shot injection molding is highly useful in creating components for the instrument cluster, it is often an impractical method for combining multiple components into a singly produced part. The impracticalities of single shot injection molding arise when individual components require varying materials or properties. Creating a component that has opaque sections as well as translucent sections, for example, can be difficult using single shot injection molding. One known solution to this limitation is through the use of multi-shot injection molding.

Multi-shot injection molding is a well known process that allows for multiple components to be formed together in a single process even when the components require different materials or properties. Although the multi-shot injection molding process is well known, its application to the formation of instrument clusters has been limited. Often the heat created by the secondary shots of injection molding is capable of warping the component created during the initial injection molding shot. Previous attempts at forming the backplate and the dial into a single element using this process have illustrated this drawback to the multi-shot injection molding process. Injection of the dial onto the backplate can warp the backplate due to the temperature of the injected dial. This is highly undesirable and has created a barrier in many circumstances to the use of multi-shot injection molding. It would be highly desirable to develop an instrument cluster that could benefit from the cost advantages of multi-shot injection molding without suffering from the disadvantages that are known to arise with the process.

### SUMMARY OF THE INVENTION

It is therefore an object of the present invention to provide an instrument cluster produced using a multi-shot injection molding process.

In accordance with the object of this invention an instrument cluster is provided. The instrument cluster includes a backplate and a mask. The backplate and the mask are formed as a single component using a single shot of injection molding. This creates a single component with enough structural rigidity to withstand a dial being directly applied to the backplate using a second shot of injection molding. An instrument cluster is thereby created with reduced assembly costs and lowered warranty concerns.

Other objects and features of the present invention will become apparent when viewed in light of the detailed description of the preferred embodiment when taken in conjunction with the attached drawings and appended claims.

### BRIEF DESCRIPTION OF DRAWINGS

FIG. 1 is an exploded view of one possible embodiment of an instrument cluster in accordance with the prior art;

FIG. 2 is an illustration of an embodiment of an instrument cluster in accordance with the present invention; and

FIG. 3 is an exploded view of an embodiment of an instrument cluster in accordance with the present invention.

### DESCRIPTION OF THE PREFERRED EMBODIMENT(S)

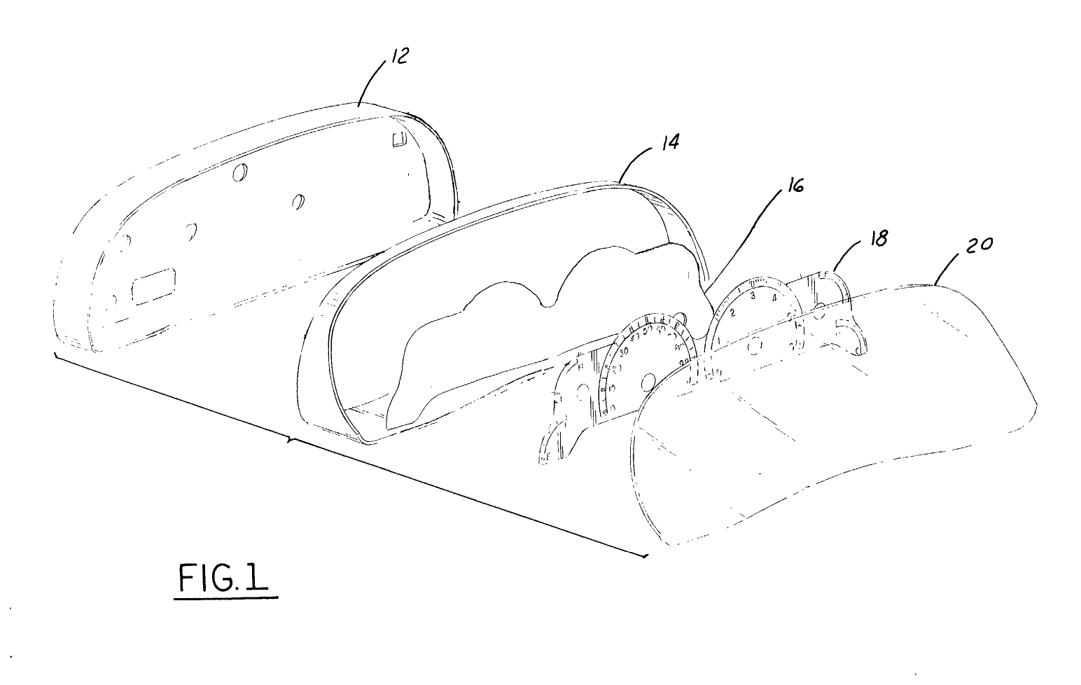

Referring now to FIG. 1 which is one possible embodiment an instrument cluster 10 in accordance with the prior art. The instrument cluster 10 includes a back plate 12, a mask 14, a dial 16, an applique 18, and a lens 20. The instrument cluster 10 may additionally include a variety of other known elements such as lighting elements (not shown) and dial mechanisms (not shown). The various components that make up the prior art instrument cluster 10 can be assembled using a variety of known methods including the use of fasteners and adhesives. It is known, however, that as the number of components that make up the prior art instrument cluster 10 increase, the time and cost of manufacturing and assembly can additionally increase. This is highly undesirable. In addition, it is known that as the incidents of fasteners and adhesive usage increase, it is possible for warranty cost to increase due to failures and rattles arising from the hostile automotive environment. This is also highly undesirable.

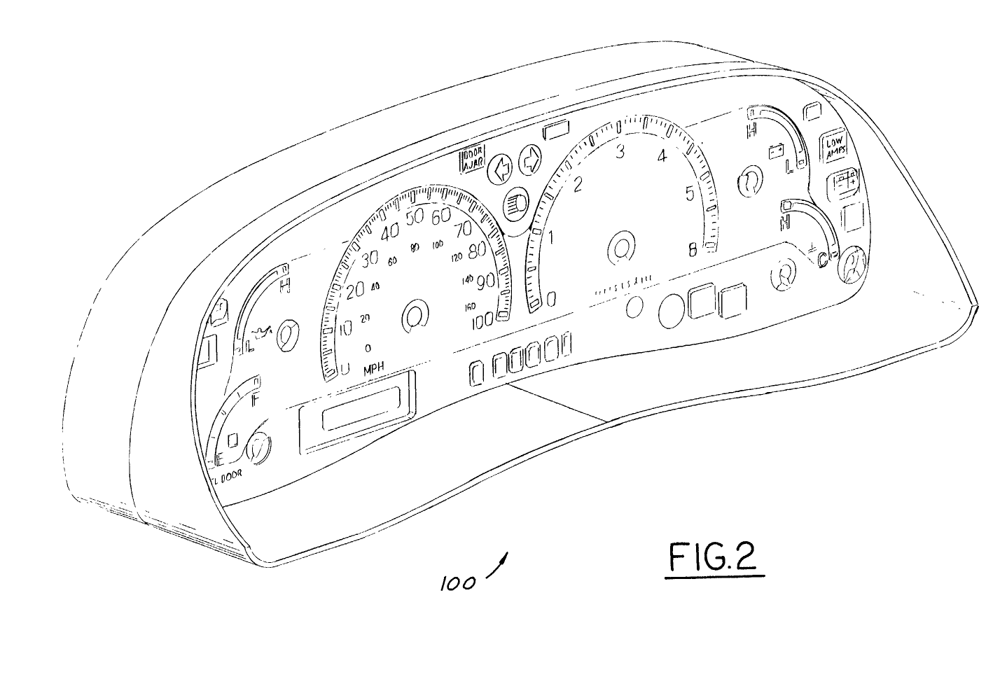

Referring now to FIG. 2, which is an illustration of an embodiment of an instrument cluster 100 in accordance with the present invention. Although the instrument cluster 100 is intended for use in automotive applications, the instrument cluster 100 is capable of being used in a variety of other applications, including non-automotive applications.

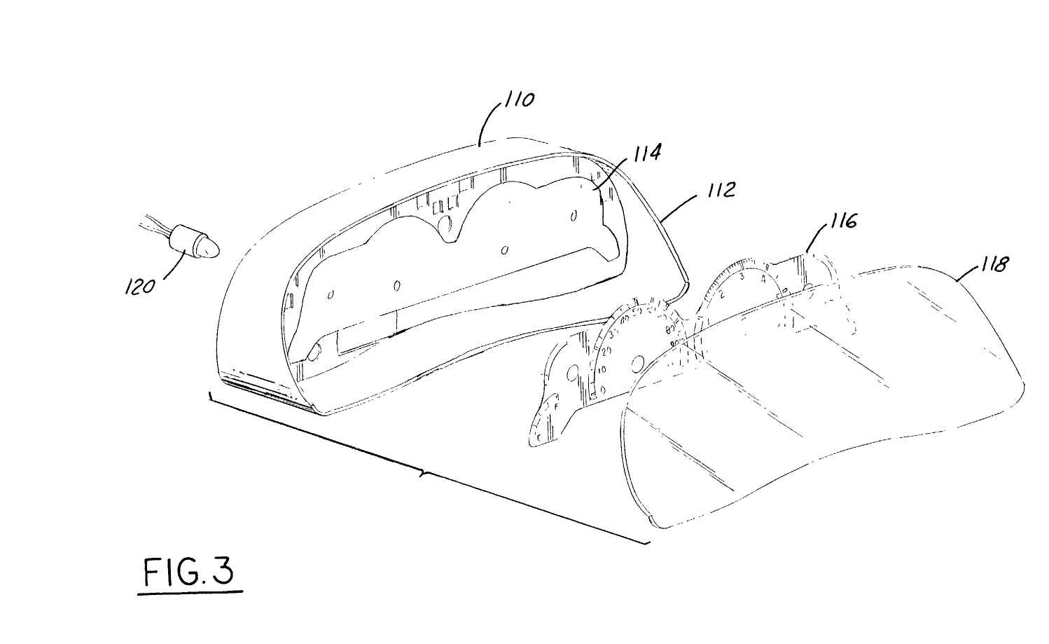

Referring now to FIG. 3, the instrument cluster 100 includes a backplate 110 and a mask 112. The backplate 110 and the mask 112 are formed as a single component using a shot of injection molding. By forming the backplate 110 and the mask 112 into a single component, the time and cost associated with manufacturing and assembly can be reduced. In addition, warranty concerns that can arise from attaching the backplate 110 to the mask 112 through the use of fasteners can be eliminated. In one embodiment, the backplate 110 and the mask 112 are comprised of ABS, although a wide variety of materials may be used.

The instrument cluster 100 further and includes a dial 114 formed onto the backplate 110 using at least one additional shot of injection molding. In one embodiment, the dial 114 comprises clear polycarbonate, although a wide variety of materials and colors may be used. Since the backplate 110 and the mask 112 are formed as a single component, they form sufficient structural rigidity such that the heat created by injecting the dial 114 onto the backplate 110 does not deleteriously warp the backplate 110. Again, this further reduces assembly time and cost and further reduces the use of fasteners and adhesives and their related warranty concerns.

Although two shots of injection molding have been described, it should be understood that a variety of additional components may be applied directly to the backplate 110 or the mask 112 using additional shots of injection molding. These components can include warning lights, colored inserts and a variety of other known components. By combining the backplate 110 and the mask 112 into a single component, a single component has thus been created that can withstand additional shots of injection molding. By increasing the number of components formed directly onto the backplate 110 and mask 112, further cost and time savings may be realized.

Although further shots of injection molding may be utilized, additional components necessary to create a functional instrument cluster 100 may be attached using traditional methods as well. In one embodiment, these additional components can include an applique 116, a lens 118, and LED backlighting 120. Although several components have been described, it should be understood that a wide variety of individual components can be added to the backplate 110/mask 112 component and the dial 116 to create a completed instrument cluster 100.

While particular embodiments of the invention have been shown and described, numerous variations and alternative embodiments will occur to those skilled in the art. Accordingly, it is intended that the invention be limited only in terms of the appended claims.

What is claimed is:

1. An instrument cluster comprising:
a backplate;
a mask, said mask and said backplate formed as a single component using a first shot of injection molding; and
a dial formed onto said backplate using a second shot of injection molding.

2. An instrument cluster as described in claim 1, further comprising:
an applique.

3. An instrument cluster as described in claim 1, further comprising:
a lens.

4. An instrument cluster as described in claim 1, wherein said dial comprises clear polycarbonate.

5. An instrument cluster as described in claim 1, wherein said mask comprises ABS.

6. An instrument cluster as described in claim 1, wherein said backplate comprises ABS.

7. An instrument cluster as described in claim 1, further comprising:
light emitting diode backlighting.

8. An instrument cluster comprising:
a backplate;
a mask, said mask and said backplate formed as a single component using at least one shot of injection molding; and
a dial formed onto said backplate using at least one additional shot of injection molding.

9. An instrument cluster as described in claim 8, further comprising:
an applique.

10. An instrument cluster as described in claim 8, further comprising:
a lens.

11. An instrument cluster as described in claim 8, wherein said dial comprises clear polycarbonate.

12. An instrument cluster as described in claim 8, wherein said mask comprises ABS.

13. An instrument cluster as described in claim 8, wherein said backplate comprises ABS.

14. An instrument cluster as described in claim 8, further comprising:
light emitting diode backlighting.

15. A method of producing an instrument cluster comprising the steps of:
forming a backplate and a mask as a single component using a first shot of injection molding; and
forming a dial onto said backplate using a second shot of injection molding.

16. A method of producing an instrument cluster as described in claim 15, wherein said dial comprises clear polycarbonate.

17. A method of producing an instrument cluster as described in claim 15, wherein said mask comprises ABS.

18. A method of producing an instrument cluster as described in claim 15, wherein said backplate comprises ABS.
